(19) United States
(12) Patent Application Publication
(10) Pub. No.: US 2006/0159979 A1
(43) Pub. Date: Jul. 20, 2006

(54) Membrane electrode assembly for improved fuel cell performance

(76) Inventors: Jake De Vaal, Coquitlam (CA); Robert M. Holland, Richmond (CA); Reto Corfu, Vancouver (CA)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 11/320,523

(22) Filed: Dec. 27, 2005

Related U.S. Application Data
(60) Provisional application No. 60/639,665, filed on Dec. 28, 2004.

(51) Int. Cl. H01M 4/86; H01M 8/10; H01M 4/94; H01M 8/04; H01M 8/02

(52) U.S. Cl. 429/40; 429/30; 429/44; 429/26; 429/38; 429/13

(57) ABSTRACT

A membrane electrode assembly comprises an ion exchange membrane, an anode positioned on one side of the membrane and a cathode positioned on the other side of the membrane so that a portion of the cathode extends outside of the anode area on the oxidant outlet side of the fuel cell such that any hydrogen leaked from the anode side to the cathode side due to any defects (holes) existing in the membrane near the oxidant outlet is recombined with the oxygen on the cathode side before it reaches the oxidant outlet and no hydrogen is present in the oxidant stream exhausted from the fuel cell.

### CROSS-REFERENCE TO RELATED APPLICATION

This application claims the benefit under 35 U.S.C. § 119(e) of U.S. Provisional Patent Application No. 60/639,665 filed Dec. 28, 2004. This provisional application is incorporated herein by reference in its entirety.

### BACKGROUND OF THE INVENTION

1. Field of the Invention

The present invention relates to a membrane electrode assembly for improved fuel cell performance, and, more specifically, to a membrane electrode assembly having a structure that enables the recombining of any hydrogen leaked from the anode side to the cathode side with the oxygen on the cathode side at a point before the oxidant outlet.

2. Description of the Related Art

Electrochemical fuel cells convert reactants, namely fuel and oxidant, into electric power through the electrochemical reactions that take place within the fuel cell. One type of fuel cell that has been used for automotive and other industrial applications because of its low operation temperature (around 80° C.) is the solid polymer fuel cell. Solid polymer fuel cells employ a membrane electrode assembly (“MEA”) that includes an ion exchange membrane disposed between two electrodes that carry a certain amount of catalyst at their interface with the membrane.

The catalyst is typically a precious metal composition (e.g., platinum metal black or an alloy thereof) and may be provided on a suitable support (e.g., fine platinum particles supported on a carbon black support). A catalyst is needed to induce the electrochemical reactions within the fuel cell. The electrodes may also comprise a porous, electrically conductive substrate that supports the catalyst layer and that is also employed for purposes of electrical conduction, and/or reactant distribution, thus serving as a fluid diffusion layer.

The MEA may be manufactured, for example, by bonding together the catalyst-coated anode fluid diffusion layer, the ion-exchange membrane and the catalyst-coated cathode fluid diffusion layer under the application of heat and pressure. Another method involves coating the catalyst layers directly onto the ion-exchange membrane to form a catalyst-coated membrane and then bonding the fluid diffusion layers thereon. The ion-exchange membranes of particular interest are those prepared from fluoropolymers that contain pendant sulfonic acid functional groups and/or carboxylic acid functional groups. A typical perfluorosulfonic acid/PTFE copolymer membrane can be obtained from DuPont Inc. under the trade designation Naflon®.

The MEA is typically disposed between two plates to form a fuel cell assembly. The plates act as current collectors and provide support for the adjacent electrodes. The assembly is typically compressed to ensure good electrical contact between the plates and the electrodes, in addition to good sealing between fuel cell components. In operation, the output voltage of an individual fuel cell under load is generally below one volt. Therefore, in order to provide greater output voltage, numerous cells are usually stacked together and are connected in series to create a higher voltage fuel cell stack. In a fuel cell stack, a plate may be shared between adjacent fuel cell assemblies, in which case the plate also serves as a separator to fluidly isolate the fluid streams of the two adjacent fuel cells. In a fuel cell, these plates on either side of the MEA may incorporate flow fields for the purpose of directing reactants across the surfaces of the fluid diffusion electrodes or electrode substrates. The flow fields comprise fluid distribution channels separated by landings. The channels provide passages for the distribution of reactant to the electrode surfaces and also for the removal of reaction products and depleted reactant streams. The landings act as mechanical supports for the fluid diffusion layers in the MEA and provide electrical contact thereto. Since, during operation, the temperature of the fuel cell may increase considerably and needs to be controlled within permissible limits, flow field plates may also include channels for directing coolant fluids along specific portions of the fuel cell.

During normal operation of a solid polymer fuel cell, fuel is electrochemically oxidized at the anode catalyst, typically resulting in the generation of protons, electrons, and possibly other species depending on the fuel employed. The protons are conducted from the reaction sites at which they are generated, through the ion-exchange membrane, to electrochemically react with the oxidant on the cathode side. The electrons travel through an external circuit providing useable power and then react with the protons and oxidant at the cathode catalyst to generate water reaction product.

A broad range of reactants can be used in solid polymer fuel cells and may be supplied in either gaseous or liquid form. For example, the oxidant stream may be substantially pure oxygen gas or a dilute oxygen stream such as air. The fuel may be, for example, substantially pure hydrogen gas, a gaseous hydrogen-containing reformate stream, or an aqueous liquid methanol mixture in a direct methanol fuel cell.

The membrane separates the reactant streams (fuel and oxidant). Reactant isolation is very important because hydrogen and oxygen are particularly reactive with each other. Therefore the leakage of the reactants to the outside of the fuel cell has a very negative impact on the fuel cell stack safety, performance and longevity. If the membrane is defective (e.g., has a hole), internal reactant transfer leaks may occur causing a lifetime-limiting failure mode for the fuel cell stack. The way this problem has been dealt with in the past is by designing fuel cell systems to run with the fuel pressure on the anode side being higher than the air pressure on the cathode side. This is done to prevent air leaking into the anode side, which causes the cell go into a fuel starvation mode. Fuel starvation can lead to cell reversals, unit cell damage, MEA shorting and possible combustion in the stack. MEAs are much less tolerant to fuel starvation than to air starvation.

When the fuel cell system runs in a slight fuel overpressure mode, hydrogen may leak from the anode side to the cathode side through one or more holes in a defective or worn-out membrane. Experimental tests have shown that, if the internal transfers do not occur close to the air outlet end of the MEA, hydrogen will be present at the cathode outlet only after the cell voltage has collapsed to near-zero. To prevent this situation, the fuel cell stack may be connected to a device for monitoring the voltages of individual cells that will shut down the system and isolate the fuel supply in the event of non-recoverable low cells. Tests have shown that if the hydrogen internal leaks occur near the air outlet, hydrogen is undesirably present in the cathode exhaust even if the cell does not drop into complete air starvation mode.

One method to address issues associated with external hydrogen leaks coming, for example, from the fuel processing subsystem of a fuel cell system is to contain the leaks within a housing. Such a housing may be provided with a recombiner that catalytically converts hydrogen and oxygen into water, as disclosed in U.S. Patent Application Publication No. 2003/0082428.

In addition, published Japanese Patent Application No. 2004146250 describes a membrane electrode assembly comprising glue lines provided between the membrane and the electrodes to seal off the fuel passage and the oxidant passage. The cathode has a larger area than the anode such that it supports the entire membrane surface to prevent any stress damage to the membrane. The anode catalyst layer and the cathode catalyst layer have substantially the same area. Although this application addresses the problem of reactant mixing at the fuel cell inlet and outlet, it does not address the problem of internal hydrogen transfer leaks through a defective or worn-out membrane.

Accordingly, although there have been advances in the field, there remains a need in the art for improved fuel cells, particularly relating to internal hydrogen transfer leaks that may occur near the oxidant outlet.

### BRIEF SUMMARY OF THE INVENTION

A membrane electrode assembly comprises an ion exchange membrane, an anode positioned on one side of the membrane and a cathode positioned on the other side of the membrane, wherein most of the area of the cathode opposes that of the anode.

A portion of the cathode extends outside of the anode area such that any hydrogen leaked from the anode side of the fuel cell to the cathode side due to any defects (e.g., holes) existing in the membrane is recombined with the oxygen on the cathode side. The anode and the cathode comprise a catalyst layer. The catalyst layer may be deposited directly on the membrane or on a fluid diffusion layer.

The membrane electrode assembly is part of a fuel cell having an oxidant inlet and outlet. In a specific embodiment, the portion of the cathode extending outside of the anode area is on the oxidant outlet side of the fuel cell so that substantially all the hydrogen leaked from the anode side to the cathode side is recombined with oxygen on the cathode side before it reaches the oxidant outlet, and thus substantially no hydrogen is present in the oxidant stream exhausted from the fuel cell. The membrane electrode assembly is interposed between two flow field plate assemblies, each comprising an internal coolant flow field, and the area of the coolant flow field extends outside of the anode area on the oxidant outlet side of the fuel cell to cover substantially the entire area of the cathode.

These and other aspects of the invention will be evident upon reference to the following detailed description and attached drawings.

### BRIEF DESCRIPTION OF THE DRAWINGS

FIG. 1 is a cross-sectional view of a fuel cell assembly as known from the prior art.

FIG. 2 is an enlarged view of a detail of the cross-section depicted in FIG. 1, showing a hole in the ion exchange membrane.

FIG. 3 is a diagram showing a comparison of the experimental test results in the case of a fuel cell with hydrogen transfer leaks occurring near the oxidant inlet and outlet.

FIG. 4 is a cross-sectional view of the fuel cell according to the present invention.

### DETAILED DESCRIPTION OF THE INVENTION

The present detailed description is generally directed toward a membrane electrode assembly that comprises a cathode extending outside of the anode area such that any hydrogen leaked from the anode side of the fuel cell to the cathode side is recombined with oxygen on the cathode side, thus reducing or eliminating hydrogen in the oxidant stream exhausted from the fuel cell.

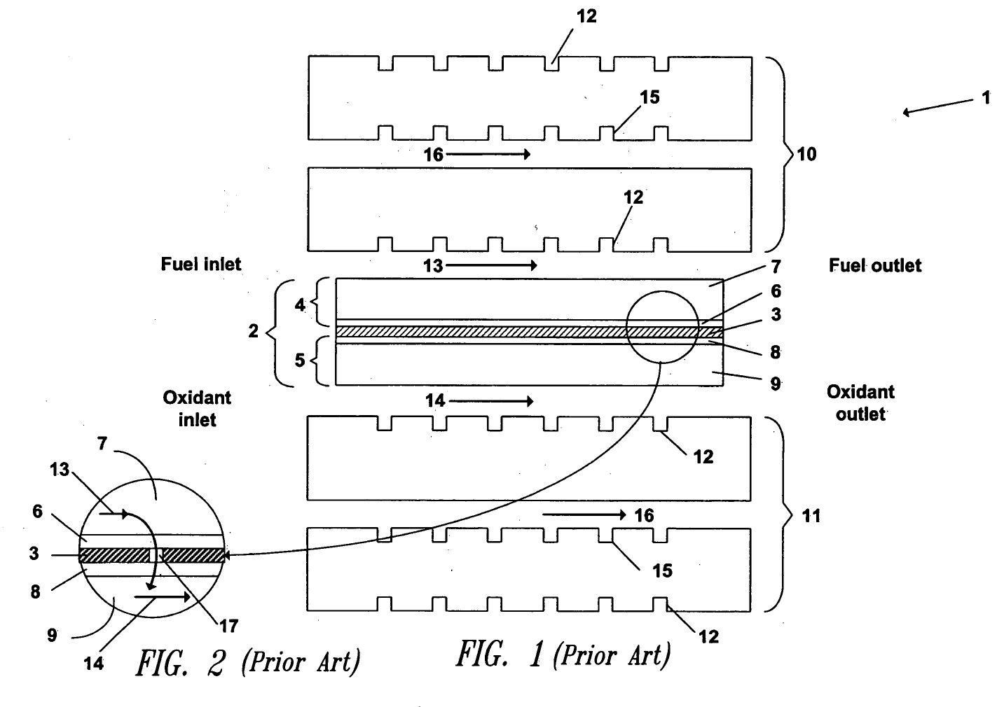

FIG. 1 illustrates a conventional fuel cell assembly. For simplicity, a single cell from a fuel cell stack is represented. It is to be understood that this represents a repeating unit of the fuel cell stack. The fuel cell 1 includes a membrane electrode assembly (MEA) 2 comprising an ion-exchange membrane 3, an anode 4 and a cathode 5. The anode 4 comprises a catalyst layer 6 and may also comprise a fluid diffusion layer 7. The cathode 5 comprises a catalyst layer 8 and may also comprise a fluid diffusion layer 9. The catalyst layer may be deposited directly on the membrane or may be deposited on the fluid diffusion layers. The MEA may be manufactured, for example, by bonding together the catalyst coated anode fluid diffusion layer, the ion-exchange membrane and the catalyst cathode fluid diffusion layer under the application of heat and pressure. Another method involves coating the catalyst layers directly onto the ion-exchange membrane to form a catalyst-coated membrane and then bonding the fluid diffusion layers thereon.

The MEA is typically interposed between two separator plate assemblies 10 and 11, which are impermeable to the reactant fluid streams. The MEA together with the separator plate assemblies form the fuel cell assembly. The separator plate assemblies include flow field channels 12 for directing reactants across one surface of each electrode. The fuel flow field channels are fluidly connected to each other to form a fuel stream 13 that is directed from the fuel inlet of the fuel cell to the fuel outlet. Similarly, the oxidant flow field channels are fluidly connected to each other to form an oxidant stream 14 that is directed from the oxidant inlet of the fuel cell to the oxidant outlet. Fuel cells are run with a slight fuel overpressure compared to the oxidant pressure to prevent fuel starvation due to the oxidant leaking to the anode side. Fuel starvation has more negative effects on the stack than oxidant starvation, leading to cell reversals, unit cell damage, MEA shorting and possible combustion in the stack.

Each of the separator plate assemblies 10 and 11 also includes coolant channels 15 that form a internal coolant flow field through which coolant circulates generating a coolant stream 16 that cools down the fuel cell and helps keeping the temperature of the stack within a permissible range (around 80° C.).

The ion-exchange membrane may be prepared from fluoropolymers containing pendant sulfonic acid functional groups and/or carboxylic acid functional groups. A typical perfluorosulfonic acid/PTFE copolymer membrane can be obtained from DuPont Inc. under the trade designation Nafion®. Referring to FIG. 2, if the membrane 3 has a defect 17, an internal transfer leak occurs between the fuel stream 13 and the oxidant stream 14 since the pressure on the fuel side is higher than the pressure on the cathode side. Such an internal transfer leaks limit the lifetime of the fuel cell and have a negative impact on the operation and performance of the fuel cell.

Experimental tests have shown that about 5% hydrogen present at the oxidant inlet of the fuel cell can be completely recombined before the leaked hydrogen reaches the oxidant outlet at 50 A. A maximum of 30% hydrogen present at the oxidant inlet of the fuel cell can be completely recombined in open circuit voltage (OCV) conditions. Once all the available oxygen supplied to the fuel cell is used to support the stack current and the hydrogen recombination into water, the fuel cell goes into air starvation mode, the cell voltage drops to near zero and hydrogen begins to be present in the cathode exhaust stream.

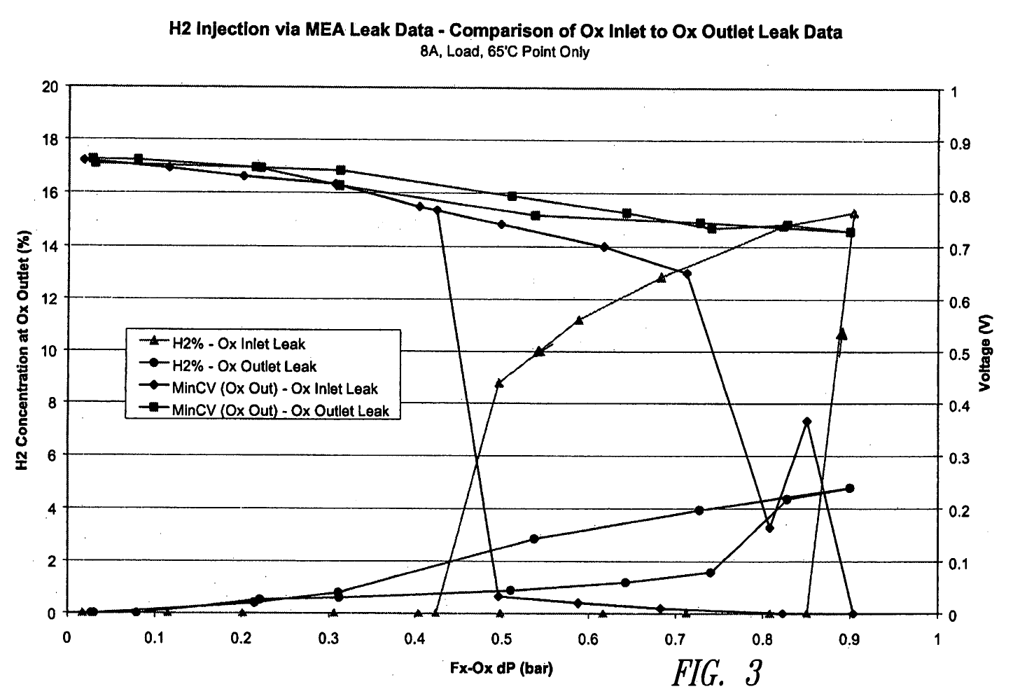

Experimental tests have shown that, unlike the case of hydrogen leaks occurring at the oxidant inlet, if the hydrogen transfer leak occurs near the oxidant outlet, hydrogen is measured at the oxidant outlet before the fuel cell drops into complete air starvation. In this case, hydrogen is measured at the air outlet almost immediately as the pressure differential increases above 0 bar as shown in FIG. 3. The relationship between the concentration of the hydrogen present at the oxidant outlet and the pressure differential between the fuel and the oxidant is approximately linear with the outlet hydrogen concentration increasing gradually as the pressure differential increases. As shown in FIG. 3, when the internal hydrogen transfer leak occurs near the oxidant outlet, the fuel cell voltage drops but does not become unstable and does not fall to zero. Such an internal leak will not be detected by the standard cell voltage monitoring device of the fuel cell system, and therefore it is preferable to prevent the negative effects of the hydrogen leaks occurring near the cathode outlet before hydrogen leaks to the outside of the fuel cell.

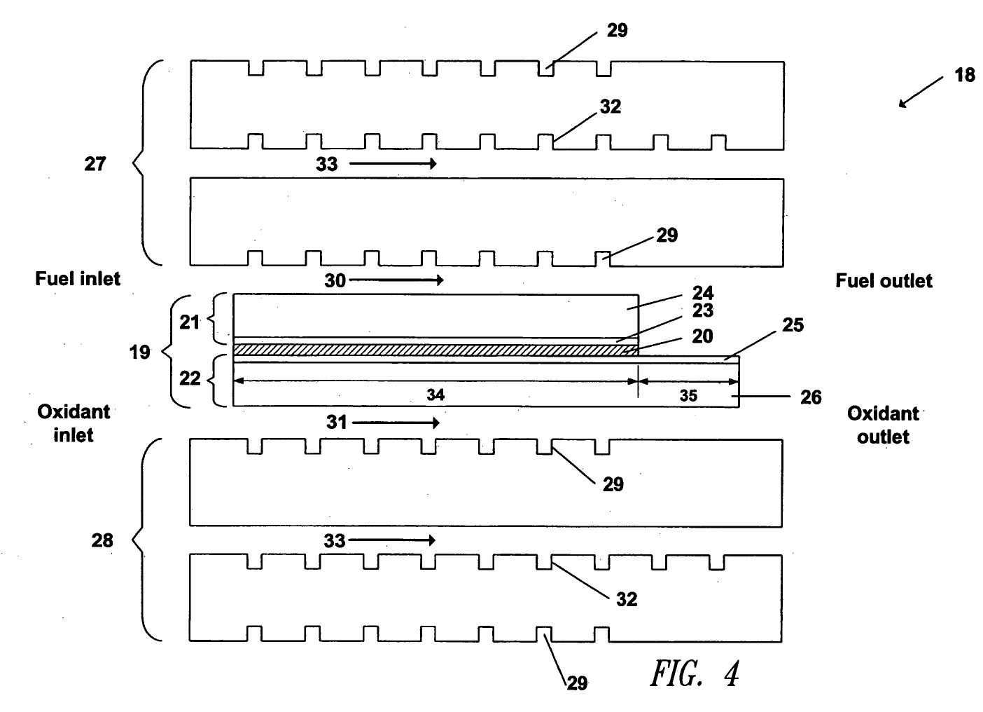

A fuel cell 18 of the present invention, depicted in FIG. 4, comprises MEA 19 comprising an ion-exchange membrane 20, an anode 21 and a cathode 22. The anode 21 comprises a catalyst layer 23 and may also comprise a fluid diffusion layer 24. The cathode 22 comprises a catalyst layer 25 and may also comprise a catalyst fluid diffusion layer 26. The MEA is typically interposed between two separator plate assemblies 27 and 28 provided with reactant flow field channels 29. The anode flow field channels are fluidly connected to each other to form a fuel stream 30 flowing from the fuel cell inlet of the fuel cell to the fuel outlet. Similarly, the oxidant flow field channels are fluidly connected to each other to form an oxidant stream 31 that is directed from the oxidant inlet of the fuel cell to the oxidant outlet. The plate assemblies are also provided with coolant channels 32 that form an internal coolant flow field through which coolant circulates generating a coolant stream 33.

As shown, most of the area of the cathode is opposing that of the anode. The area where the anode and cathode overlap is referred to as the “active area” 34, and is the area of the fuel cell that enables the catalyst induced electrochemical reactions between fuel and oxidant to generate electrical energy. A portion 35 of the cathode, referred to as the “hydrogen recombination area”, extends outside of the anode area and therefore outside of the active area of the fuel cell. The length of portion 35 will differ between embodiments of the present invention as a function of reactant flow and hydrogen concentration in the cathode oxidant stream 31. In certain embodiments, the length of portion 35 is about 1.5 to 10% of the length of active area 34. If an internal hydrogen leak occurs near the oxidant outlet due to a defect in the membrane, substantially all of the leaked hydrogen will be recombined beyond the active area of the fuel cell, and within the hydrogen recombination area, before it reaches the oxidant outlet.

Membrane 20 may cover substantially the entire area of the anode (as shown in FIG. 4) or may extend outside of the anode area and cover substantially the entire area of the cathode. In either embodiment, membrane 20 serves to prevent reactant mixing and short-circuiting.

The hydrogen recombination reactions that take place outside of the active area generate heat and have a negative impact on the thermal balance of the fuel cell. To address this issue, the coolant flow field may be extended beyond the active area of the fuel cell so that the coolant channels 32 cover the entire area of the extended cathode (i.e., including the hydrogen recombination area).

By extending the cathode and the corresponding coolant flow field, negative effects of internal hydrogen transfer leaks occurring near the oxidant outlet, that can go easily undetected by voltage monitoring devices, are prevented. Any hydrogen that may be present in the cathode exhaust is caused only by the internal hydrogen transfer leaks occurring at the oxidant inlet and only after the cell voltage has dropped to near-zero as indicated by the fuel cell system voltage monitoring device. Consequently, the stack will drop in performance before a flammability hazard exists in the oxidant exhaust. In the event of non-recoverable low cells the fuel cell system will shut down.

While particular steps, elements, embodiments and applications of the present invention have been shown and described, it will be understood, of course, that the invention is not limited thereto since modifications may be made by persons skilled in the art, particularly in light of the foregoing teachings. It is therefore contemplated by the appended claims to cover such modifications as incorporate those steps or elements which come within the spirit and scope of the invention.

What is claimed is:

1. A membrane electrode assembly for improved fuel cell performance comprising:
an ion-exchange membrane,
an anode positioned on one side of the membrane; and
a cathode positioned on the opposite side of the membrane, most of the area of the cathode opposing that of the anode,
wherein a portion of the cathode extends outside of the anode area.

2. The membrane electrode assembly of claim 1 wherein the anode comprises an anode diffusion layer coated with a catalyst layer and the cathode comprises a cathode diffusion layer coated with a catalyst layer.

3. The membrane electrode assembly of claim 1 wherein the ion-exchange membrane covers substantially the entire area of the anode.

4. The membrane electrode assembly of claim 1 wherein the ion-exchange membrane covers substantially the entire area of the cathode.

5. A fuel cell comprising the membrane electrode assembly of claim 1, wherein the fuel cell has an oxidant inlet and outlet and the portion of the cathode extending outside of the anode area is on the oxidant outlet side of the fuel cell.

6. The fuel cell of claim 5 wherein the membrane electrode assembly is interposed between two flow field plate assemblies, each comprising an internal coolant flow field, and wherein the area of each internal coolant flow field extends outside of the anode area on the oxidant outlet side of the fuel cell to cover substantially the entire area of the cathode.

7. A fuel cell stack comprising at least one of the fuel cell according to claim 5 or claim 6.

8. A fuel cell system comprising the fuel cell stack of claim 7, wherein any hydrogen leaked from the anode side to the cathode side of the at least one fuel cell is recombined with the oxygen on the cathode side at a point before the oxidant outlet.

9. A method of improving the performance of a fuel cell comprising an ion-exchange membrane, the method comprising arranging an anode on one side of the membrane and a cathode on the opposite side of the membrane, such that most of the area of the cathode opposes that of the anode, a portion of the cathode extends outside of the anode area, and any hydrogen leaked from the anode side of the fuel cell to the cathode side is substantially recombined with the oxygen on the cathode side at a point before an oxidant outlet of the fuel cell.
